(19) United States
(12) Patent Application Publication
(10) Pub. No.: US 2005/0089377 A1
(43) Pub. Date: Apr. 28, 2005

(54) Protective ground mat

(76) Inventor: David M. Allen, Howell, MI (US)

Correspondence Address: HARNESS, DICKEY & PIERCE, P.L.C., P.O. BOX 828, BLOOMFIELD HILLS, MI, 48303, US

(21) Appl. No.: 10/693,136

(22) Filed: Oct. 24, 2003

(51) Int. Cl. E02D 3/00; C09K 17/00

(52) U.S. Cl. 405/302.7; 405/302.4

(57) ABSTRACT

A protective ground mat having a non-rigid base, a plurality of hold-downs that are coupled to the base, and a plurality of tensioners. Each tensioner has a first portion and a second portion that may be selectively coupled to the first portion to adjust a distance between an associated pair of the hold-downs. The tensioners permit the protective ground mat to be tightened against the ground during installation.

The present invention generally relates to a removable landscape cover that may be easily installed to the ground in a manner that readily conforms to the contour of the ground.

The winter months often present significant challenges to property owners who must consider the maintenance of a given piece of property for vehicular and pedestrian traffic, but also the impact of the cold weather and such maintenance on the property itself. For example, heavy use of salt during the winter months may aid vehicular and pedestrian traffic, but could adversely affect the health and viability of any near by trees, shrubs and other plants.

Another example concerns areas, such as grassy medians, that may from time to time be used for pedestrian traffic. The pedestrian traffic in combination with the cyclic freezing and thawing that is typically experienced in such areas can quickly fill the area with slush and mud.

One solution for preventing salt damage to trees is found in U.S. Pat. No. 5,878,528 to Pattyn. This solution employs a conical, rigid, self-supporting sheet of weather-resistant material that is fitted about the tree. This solution, however, has several drawbacks. One significant drawback is the difficulty in sizing the tree protector to a particular application. Specifically, it appears that the tree protector must not only be sized to the tree, but also to the ground about the tree so that the tree protector conforms to the contour of the ground, whether or not a mulch bed has been put about the tree. Both tasks can be somewhat time consuming and/or difficult, bearing in mind the variety in the sizes of trees and that mulch beds are rarely ever perfectly round. Additionally, this tree protector cannot be employed to cover areas that may from time to time be used for pedestrian traffic due to its rigid construction.

Accordingly, there remains a need in the art for an improved protective ground mat which may be employed to cover the ground in a desired area in a manner that permits the protective ground mat to conform to the shape of the area to be covered and the contour of the ground in that area.

### SUMMARY

In one form, the present teachings provide a protective ground mat having a non-rigid base, a plurality of hold-downs that are coupled to the base, and a plurality of tensioners. Each tensioner has a first portion and a second portion that may be selectively coupled to the first portion to adjust a distance between an associated pair of the hold-downs.

In another form, the present invention provides a method of installing a protective ground mat to the ground, the protective ground mat having a non-rigid base. The method includes: securing the protective ground mat to the ground at a plurality of locations; and tensioning the base after it has been secured to the ground so that it conforms to a contour of the ground.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Additional advantages and features of the present invention will become apparent from the subsequent description and the appended claims, taken in conjunction with the accompanying drawings, wherein:

FIG. 1 is a perspective view of a median in a parking lot with protective ground mats constructed in accordance with the teachings of the present invention installed thereto;

FIG. 2 is a top plan view of another protective ground mat constructed in accordance with the teachings of the present invention;

FIG. 3 is a perspective view of a portion of the protective ground mat of FIG. 2 illustrating a slit in the base;

FIG. 4 is a partial top plan view of another protective ground mat constructed in accordance with the teachings of the present invention illustrating an alternate configuration of perforations;

FIG. 5 is a view similar to that of FIG. 4 but illustrating another alternate configuration of perforations;

FIG. 6 is a bottom view of another protective ground mat constructed in accordance with the teachings of the present invention illustrating one type of cutting indicia;

FIG. 7 is a sectional view of a portion of a protective ground mat similar to that of FIG. 2 but illustrating an alternate method for closing the slit;

FIG. 8 is a side elevation view of a portion of a protective ground mat constructed in accordance with the teachings of the present invention;

FIG. 9 is a sectional view of a portion of a protective ground mat constructed in accordance with the teachings of the present invention illustrating a hold-down in operative association with one type of grate fastener;

FIG. 10 is a sectional view of a portion of a protective ground mat constructed in accordance with the teachings of the present invention illustrating a hold-down in operative association with one type of ground stake;

FIG. 11 is a sectional view of a portion of a protective ground mat constructed in accordance with the teachings of the present invention illustrating a hold-down in operative association with another type of grate fastener;

FIG. 12 is a partial side view of the grate fastener of FIG. 11; and

FIG. 13 is a side elevation view of the protective ground mat of FIG. 2 in operative association with the ground and surrounding a tree.

### DETAILED DESCRIPTION OF THE VARIOUS EMBODIMENTS

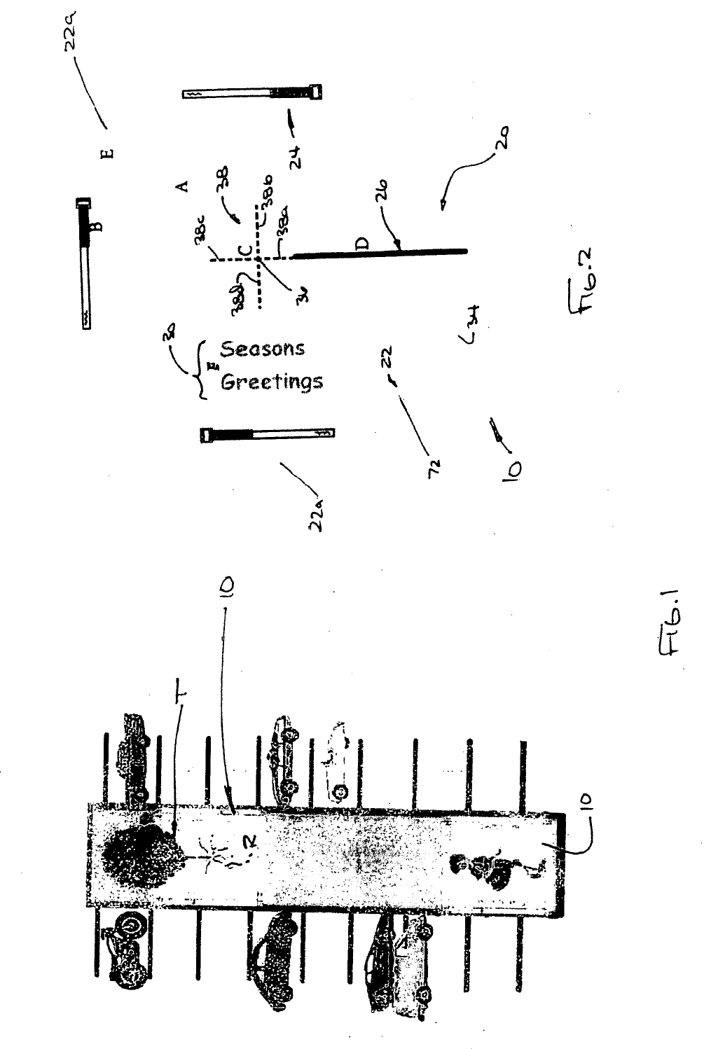

With reference to FIG. 1 of the drawings, a protective ground mat constructed in accordance with the teachings of the present invention is generally indicated by reference numeral 10. The protective ground mat 10 is illustrated in the particular example provided to be disposed about a tree (T) to cover and protect the roots (R) thereof. Those skilled in the art will appreciate from this disclosure, however, that the protective ground mat of the present invention has numerous other uses, several of which are discussed in detail below. Moreover, the shape of the protective ground mat 10 need not be square as is shown in the particular example provided but rather may be of any desired shape.

With reference to FIG. 2, the protective ground mat 10 may include a base 20, a plurality of hold-downs 22, a plurality of tensioners 24 and at least one closure device 26.

The base 20 may be formed from any non-rigid (i.e., non-self supporting), water and tear resistant material that may permit the protective ground mat 10 to be readily folded for storage and transport. The material may also be UV resistant and/or breathable. One type of material that may be used is a reinforced vinyl, such as a 13 ounce Dura Tuff #4798 reinforced vinyl manufactured by Dura Cote. Moreover, the color of the material may be selected in accordance with the use of the protective ground mat 10. In the example of FIG. 1, relatively light colors, e.g., white or yellow, may be desirable so as to limit the amount of solar energy that is absorbed by the protective ground mat 10 and transmitted to the ground. In other applications, the color may be selected to permit the protective ground mat 10 to absorb solar energy or for decorative purposes. To further enhance the decorative aspect of the base 20, decorative indicia 30, such as a logo, name, seasonal greeting and/or depiction, may be “affixed” (e.g., embroidered, bonded, printed, embossed) to the base 20.

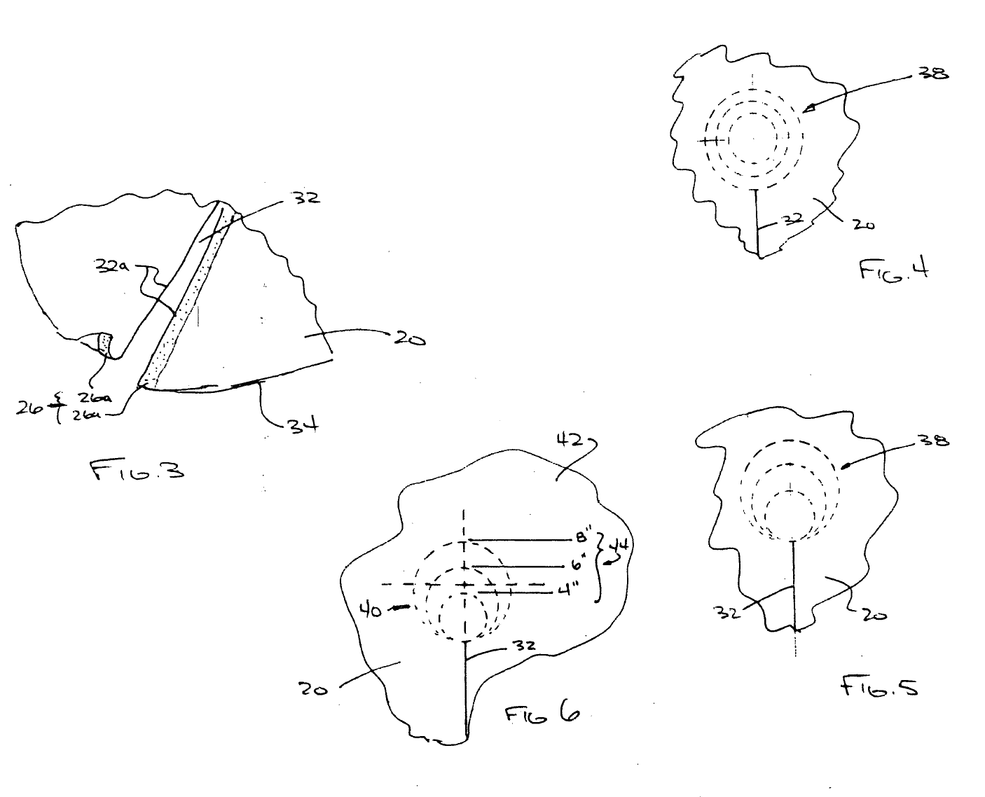

With additional reference to FIG. 3, the base 20 is formed with one or more slits 32 that extend inwardly from an outer edge 34 of the base 20. The slit or slits 32 may follow any desired course, such a generally linear course as is shown in the example provide, an arcuate course, a zigzag course, a course with combinations of one or more of the aforementioned shapes, etc. Furthermore, the slit or slits 32 may intersect a desired location on the base 20, such as the center of the shape that defines the base 20 or an aperture (not shown) formed in the base 20. In the example provided, the slit 32 extends from the outer edge 34 of the base 20 inwardly toward the center 36 and terminates at a series of perforations 38. The series of perforations 38 may intersect one another, as is the case in the example provided, or may define one or more desired shapes, such as a circle. It is expressly contemplated that where the series of perforations 38 define several shapes, the shapes (e.g., a set of circles, triangles, quadrilaterals or polygons) may be disposed inside (see, e.g., FIG. 4) and/or abutting one another (see, e.g., FIG. 5) or may define several different shapes that are disposed inside and/or abutting one another. The series of perforations 38 permit the base 20 to be readily cut or torn in a predetermined shape as needed when the protective ground mat 10 is fitted around an object, such as the tree (T) of FIG. 1. Those skilled in the art will appreciate from this disclosure that the series of perforations 38 are optional and may be omitted altogether or replaced with cutting indicia 40 as shown in FIG. 6. The cutting indicia 40 may be marked on the bottom surface 42 of the base 20 so as not to be visible when the protective ground mat 10 is installed. The cutting indicia 40 may not only include marks that indicate where the base 20 may be cut, but may also include a scale 44 or other markings that provide the installer with an idea of size of the opening that is to be formed in the base 20.

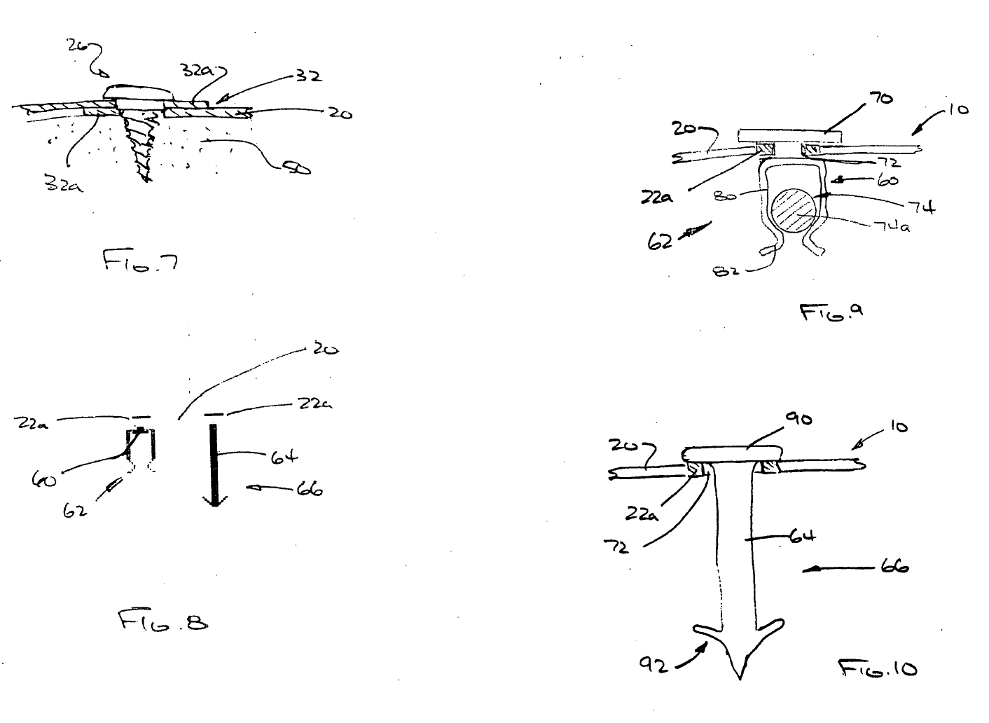

Returning to FIGS. 2 and 3, the closure device 26 is employed to close an associated slit 32. More specifically, the closure device 26 is employed to secure the edges 32a of the base 20 that define the slit 32 to be secured to one another. In the particular example illustrated, the closure device 26 includes conventional and well known hook-an-loop fasteners (e.g., VELCRO ®) 26a, but may additionally or alternatively employ one or more snaps, buckles, buttons, zippers, hooks, ropes, cords, rivets or stake-like objects. Accordingly, the closure device 26 may be employed to directly secure the edges 32a to one another or to another object, such as the ground 50 (FIG. 7) or a tack strip (not shown).

Returning to FIGS. 2 and 3, the hold-downs 22 may be spaced about the base 20 and are employed to secure the base 20 to the ground. In the example provided, the hold-downs 22 are grommets 22a and may be spaced about the perimeter of the base 20 at desired locations, which may be spaced apart at regular intervals. With additional reference to FIG. 8, each grommet 22a may be sized to receive therethrough the body 60 of a grate fastener 62 or the body 64 of a ground stake 66.

With reference to FIG. 9, an exemplary grate fastener 62 may include a head 70 that is coupled to the body 60 and sized relatively larger than the opening 72 in the grommet 22a, while the body 60 is configured to engage a conventional tree grating 74 that may be installed about a tree (not shown). The head 70 may be formed with any desired profile and may have a relatively short profile height so as to minimize the distance from which it may protrude from the base 20 when the protective ground mat 10 is installed. In the example provided, the tree grating 74 includes a grate member 74a. The body 60 of the grate fastener 62 may be formed with a pair of arms 80 that are spaced apart from one another so as to fit around the grate member 74a. Each arm 80 may include one or more fingers 82 that may be shaped to engage the grate member 74a. The arms 80 may be resiliently biased away or mechanically driven apart from one another so that once the fingers 82 are engaged to the grate member 74a, the grate fastener 62 may not be withdrawn from the tree grating 74 without manual intervention. Such manual intervention may take the form of pulling the grate fastener 62 or pushing the arms 80 apart from one another.

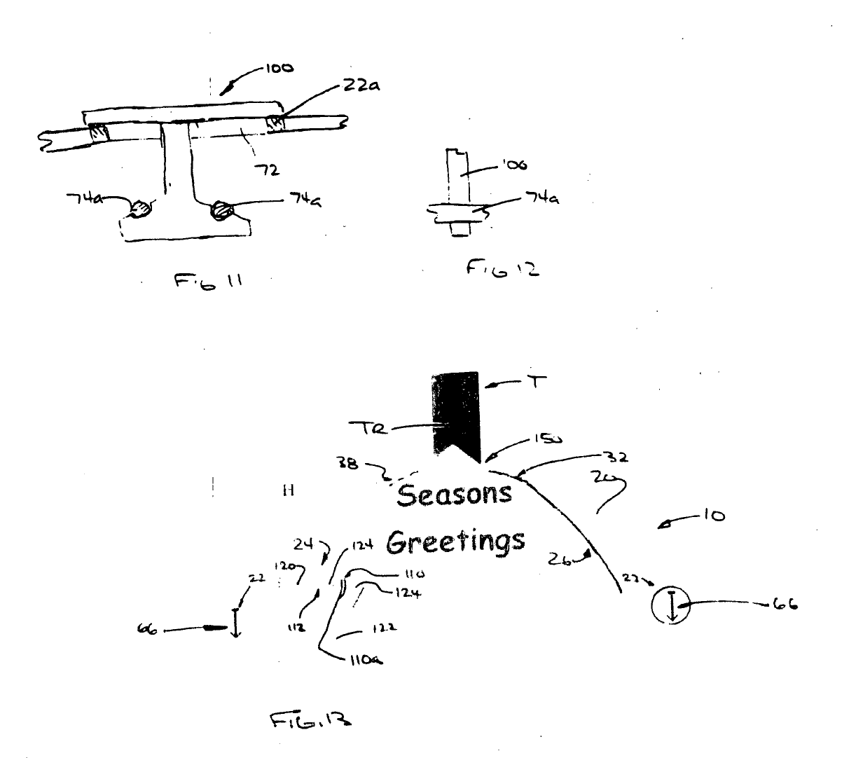

With reference to FIG. 10, the ground stake 66 also includes a head 90 that is sized relatively larger than the opening 72 in the grommet 22a. The body 64 of the ground stake 66 may be of any cross-sectional shape and may terminate at its distal end in any shape, including a blunt, pointed or barbed shape or combinations thereof. The barbed shape 92 may be useful to prevent the ground stakes 66 from being forced out of the ground in response to cyclic heating and freezing (i.e., heaving)

From the foregoing, those skilled in the art will appreciate from this disclosure that various other types of hold-downs 22 may be substituted for or employed in conjunction with the grommets 22a that are described above. Non-limiting examples of other types of hold-downs 22 include loops, tabs, hooks and lengths of material (e.g., rope, cord, VELCRO ® fabric). Note, too, that it is expressly contemplated that the hold-downs 22 themselves be employed to secure the base 20 to the ground (e.g., a length of VELCRO ® fabric that is employed to secure the base 20 or a portion thereof to one or more of the grate members 74a) and that various other types of fasteners, including threaded anchors, which may threadably engage the ground or another structure to which the protective ground mat 10 is to be secured, and “T” fasteners. One suitable T fastener 100 is illustrated in FIGS. 11 and 12, which may be inserted between the grate members 74a and rotated through a predetermined angle (e.g., 90°) to engage the “T” fastener to the lower surface of the grate members 74a.

With reference to FIG. 13, each tensioner 24 may include a first tensioner portion 110 and a second tensioner portion 112 that may be adjustably secured to the first tensioner portion 110 to selectively tighten or constrict the base 20 at a desired location between two of the hold-downs 22. In the example provided, the first tensioner portion 110 includes one or more loops 110a and the second tensioner portion 112 includes a segment of material that includes a conventional hook-and-loop fastener (e.g., VELCRO ®). The segment is fixedly coupled to the base 20 at a first end 120 and the second end 122 is threaded through the loops 110a. The segment may be pulled such that the first end 120 is moved toward the loops 110a to thereby tighten or constrict the base 20 in a desired manner and thereafter the hook and loops (not specifically shown) of the hook-and-loop fastener 124 may be engaged to one another. In the particular example provided, the tensioners 24 may be employed to vary the length and width dimensions of the base 20 from approximately 8 feet to approximately 4 feet.

Those skilled in the art will appreciate from this disclosure that various other devices may be employed in addition to or lieu of the hook-and-loop fasteners 124 and loops 110a. Accordingly, the plurality of tensioners 24 may include one or more snaps, buckles, buttons, zippers, hooks, cords and/or ropes that permit the tensioner 24 to be employed in at least an expanded condition and a tightened or constricted condition.

With reference to FIGS. 2 and 13, the protective ground mat 10 may be installed about an object, such as the tree (T) by forming an aperture 150 in the base 20 that is sized to receive the object therethrough. In the particular example illustrated, the series of perforations 38 may be employed to form the aperture 150. More specifically, the perforation 38a may be cut or torn between the inner end of the slit 32 and the center 36 of the series of perforations 38. Each of the perforations 38b, 38c and 38d may be cut or torn so that the size of the aperture 150 matches that of the trunk (TR) of the tree (T). The base 20 is fitted about the trunk (TR) such the trunk (TR) is disposed in the aperture 150 and the slit 32 is closed via the closure device 26. In the example illustrated, the closure device 26 employs hook-and-loop fasteners, so that the edges 32a (FIG. 3) of the base 20 proximate the slit 32 need only be overlapped and pressed together.

The hold-downs 22 are next employed to secure the base 20 to the ground. In this regard, the base 20 may be positioned against the ground such that one or more of the hold-downs 22 are positioned somewhat inwardly toward the center 36 of the base 20. The base 20 may be flattened against the ground (i.e., flattened against but not necessarily conforming to the contour of the ground) and the hold-downs 22 employed to secured to base 20 to the ground. In the example provided, ground stakes 66 are positioned in the opening 72 of the grommets 22a and driven into the ground.

Thereafter, one or more of the tensioners 24 may be adjusted to “tension” the base 20 so that it substantially conforms to the contour of the ground. Significantly, the tensioners 24 permit the protective ground mat 10 to be securely fastened to the ground about its entire perimeter, even when the center 36 of the base 20 is elevated to some degree, as when mulch is disposed about the trunk (TR) of the tree (T). Accordingly, the protective ground mat of the present invention may be employed to protect trees, shrubs, other plants and landscape objects from harsh weather and/or salt.

While the invention has been described in the specification and illustrated in the drawings with reference to various embodiments, it will be understood by those skilled in the art that various changes may be made and equivalents may be substituted for elements thereof without departing from the scope of the invention as defined in the claims. Furthermore, the mixing and matching of features, elements and/or functions between various embodiments is expressly contemplated herein so that one of ordinary skill in the art would appreciate from this disclosure that features, elements and/or functions of one embodiment may be incorporated into another embodiment as appropriate, unless described otherwise, above. Moreover, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the foregoing description and the appended claims.

1. A protective ground mat comprising:
a non-rigid base;
a plurality of hold-downs coupled to the base; and
a plurality of tensioners, each tensioner having a first portion and a second portion that may be selectively coupled to the first portion to adjust a distance between an associated pair of the hold-downs.

2. The protective ground mat of claim 1, wherein the base includes a pair of edges that cooperate to define a slit and wherein the protective ground mat further includes a closure device for selectively closing the slit.

3. The protective ground mat of claim 2, wherein the closure device includes at least one of: a hook and loop fastener and a zipper.

4. The protective ground mat of claim 2, wherein the slit extends from an outer edge of the base to a point outwardly of a center of the base.

5. The protective ground mat of claim 4, wherein the slit terminates inwardly at a series of perforations.

6. The protective ground mat of claim 5, wherein the series of perforations define a plurality of intersecting lines.

7. The protective ground mat of claim 5, wherein the series of perforations define a plurality of shapes.

8. The protective ground mat of claim 7, wherein each shape is disposed inside or abuts another one of the shapes.

9. The protective ground mat of claim 2, wherein the tensioners include a loop and a strap, the loop being secured to the base, the strap having a first end, which is secured to the base, and a second end that is disposed through the loop.

10. The protective ground mat of claim 2, wherein an aperture is formed in the base and the slit intersects the aperture.

11. The protective ground mat of claim 2, further comprising cutting indicia on the base.

12. The protective ground mat of claim 11, wherein the cutting indicia defines a plurality of shapes.

13. The protective ground mat of claim 12, wherein each shape is disposed inside or abuts another one of the shapes.

14. The protective ground mat of claim 13, wherein the shapes are concentric with one another.

15. The protective ground mat of claim 12, wherein each of the shapes is similar but differently sized.

16. A protective ground mat comprising:
a non-rigid base, the base includes a pair of edges that cooperate to define a slit;
a closure device for selectively closing the slit, the closure device including at least one of a hook and loop fastener and a zipper;
a plurality of hold-downs coupled to the base; and
a plurality of tensioners, each tensioner having a first portion and a second portion that may be selectively coupled to the first portion to adjust a distance between an associated pair of the hold-downs;
wherein a series of perforations are formed in the base and the slit terminates inwardly at a series of perforations.

17. A method of installing a protective ground mat to the ground, the protective ground mat having a non-rigid base, the method comprising:
securing the protective ground mat to the ground at a plurality of locations; and
tensioning the base after it has been secured to the ground so that it conforms to a contour of the ground.

18. The method of claim 17, wherein prior to securing the protective ground mat to the ground, the method includes opening a slit in the base and fitting the base about an object.

19. The method of claim 18, wherein the step of fitting the base about an object includes forming a hole in the base, the hole intersecting the slit.
